(19) United States
(12) Patent Application Publication
(10) Pub. No.: US 2004/0230838 A1
(43) Pub. Date: Nov. 18, 2004

(54) Process for assembling a group of elements in a home automation network

(76) Inventor: Eric Cheron, Taninges (FR)

Correspondence Address: WELSH & KATZ, LTD, 120 S RIVERSIDE PLAZA, 22ND FLOOR, CHICAGO, IL, 60606, US

(21) Appl. No.: 10/817,076

(22) Filed: Apr. 2, 2004

(30) Foreign Application Priority Data
Apr. 14, 2003 (FR) 0304638

(51) Int. Cl. H04L 9/00

(52) U.S. Cl. 713/201

(57) ABSTRACT

The process for assembling a group of networked elements controlling equipment of a building, is one wherein when the elements are in a learning mode,

a first action exerted on one of the elements is interpreted as an interrogation concerning its state of membership in the group (included—excluded) and triggers the emission of an information signal regarding its state, and

a following action exerted on this element is interpretable as an order for modifying its state of membership in the group.

### BACKGROUND OF THE INVENTION

The invention relates to a process for assembling a group of networked elements controlling equipment of a building. It relates furthermore to an installation comprising equipment of a building, which equipment is controlled by networked elements, which installation is intended for implementing such a process, each element comprising a programming means, an information signal emission means, a memory containing a program for detecting command of placement in learning mode and a program for detecting end of placement in learning mode.

Patent FR 2 755 259, the content of which is incorporated by reference, discloses a process for matching an element belonging to a home automation network.

This process can be implemented by a home automation installation exhibiting various referenced elements or appliances constituting a network and making it possible to control equipment of a building, such as products for closure, for shuttering for solar protection, for lighting, for alarm or else for thermal regulation. Communication between these various elements is, for example, undertaken by electromagnetic waves or by wire means according to a specific protocol.

Each element of the home automation network comprises a communication interface and inputs and outputs (not represented) allowing it respectively to receive information delivered by sensors and to drive actuators linked to the equipment of the building.

Each element of the network also comprises a programming means making it possible, on the basis of a direct action of the user, to toggle the element into a learning mode as well as a means of emitting an information signal. The programming means and the means of emitting information signals may be physically integrated into the elements or be sited remotely near auxiliary appliances connected to the elements by wire or wireless means. The link between the auxiliary appliances and the elements may in particular be effected by way of the communication network if a specific pairing exists between them.

The means of generating information signals may generate for example a luminous signal for example through the intermediary of light-emitting diodes or an audible signal. The means of emitting information signals may also consist of an activation of the controlled equipment, for example: a lighting up of an electric lamp if the item of equipment is a lighting device or an instigating of movement if the item of equipment is a rolling shutter.

### DESCRIPTION OF THE PRIOR ART

The prior art describes a process making it possible to hook up, in the form of groups, several elements of a home automation network of this type, for example so that these elements can execute a common task on receipt of an order emitted by one of them. Membership in a group can consist, for example, of the knowledge of one and the same group name, of the knowledge of the address of a master element or of the sharing of a common key or of a common seed.

The process for assembling a group according to the prior art is described with reference to FIG. 1. Time flows vertically from top to bottom on this flowchart. Initially, it is assumed that the home automation network already comprises a group assembled from the elements B0, B1 and B2 and it is assumed that the aim of the installer is to exclude B1 from the group and to include B4 in it.

During a first step E1, the installer actuates the means of programming of the element B0 consisting of a pushbutton BPP. This pressing constitutes the action referenced A0. This action triggers a step E2 in which a command CMR, the so-called hookup command is emitted over the network, accompanied by the address @B0 of the appliance B0.

During a step E3 following the receipt of this command CMR by the whole collection of network elements, the latter toggle into a learning mode in which they provisionally record the address @B0. The elements B1 and B2 already hooked up to the element B0 emit an information signal signaling their linkup to the element B0. This signaling is represented by a thick black line.

During a following step E4, the installer presses the pushbutton for programming the element B1. This action is referenced A1.

This action is interpreted in step E5 as an order for removing the existing hookup between the element B1 and the elements B0, B1 and B2. When this hookup is removed, the emission of the information signal is deactivated and a message may possibly be addressed to the element B0 to inform it of the removal of the hookup.

During a step E6, the installer presses the pushbutton for programming the element B4. This action is referenced A2.

In step E7, this action is interpreted as an order for creating a hookup between the element B4 and the elements B0, B2 and B3. Once the hookup has been created, an information signal regarding membership of the element B4 in the group comprising the element B0 is activated and a message may possibly be addressed to the element B0 to inform it of the creation of the hookup.

In step E8, when all the desired modifications within the group have been made, the installer again presses the pushbutton for programming the element B0. This action referenced E3 is interpreted as an end of group assembly session. It triggers a step E9 during which an end of learning mode command CFMR is emitted over the network.

On receipt of this command, during a step E10, all the elements deactivate the learning mode. The hookups established or removed remain so and define a group at least up to a next group assembly session.

This process has drawbacks. Firstly, it requires the emission of a continuous information signal throughout the group assembly session, which may prove to be lengthy in particular when the installation is complex, the building possibly comprising several storeys and the elements of the network possibly being rather inaccessible. Thus, in the case of elements powered autonomously, this prolonged consumption is detrimental. Next, the emission of a continuous signal is problematic when the signal is emitted by the activation of the equipment of the installation. For example, when the signal is a to-and-fro movement of a motorized rolling shutter, the prolonged emission of this signal may constitute a visual and audible nuisance.

### SUMMARY OF THE INVENTION

The aim of the invention is to provide a process for assembling a group of elements in a home automation network alleviating the above drawbacks and improving the known processes of the prior art. In particular, the invention proposes a process making it possible to avoid unnecessary usage of energy to signal the membership or non-membership of the elements in a group and to avoid engendering the emission of nuisance signals. The invention also proposes an installation allowing the implementation of such a process.

The process according to the invention is one wherein when the elements are in a learning mode,

a first action exerted on one of the elements is interpreted as an interrogation concerning its state of membership in the group (included—excluded) and triggers the emission of an information signal regarding its state, and

a following action exerted on this element is interpretable as an order for modifying its state of membership in the group.

The emission of an information signal consequent upon an action on the element is a first means for limiting its duration insofar as, in contradistinction to the known process of the prior art, the emission of the signal is not effected right from the toggling of the elements into the learning mode.

The element may emit this information signal during a timeout. This constitutes a second means for limiting the duration of emission.

Various modes of execution of the process are defined by the dependent claims 2 to 7.

The installation according to the invention is one wherein the memory of each element comprises a program for detection of action on the means of programming, of management of timeouts and of emission of an information signal.

At least one of the elements may exhibit a programming means and/or a means of emission of information signal physically separate from the element.

### BRIEF DESCRIPTION OF THE DRAWINGS

The appended drawing represents, by way of example, a mode of execution of the process according to the invention.

FIG. 1 is a time chart illustrating a known prior art group assembly process.

FIG. 2 is a time chart illustrating a mode of execution of the group assembly process according to the invention.

FIG. 3 is a diagram of an installation allowing the implementation of the process according to the invention.

FIG. 4 represents a series of temporal graphics making it possible to illustrate various alternatives of the execution of the process according to the invention.

### DESCRIPTION OF THE PREFERRED EMBODIMENT(S)

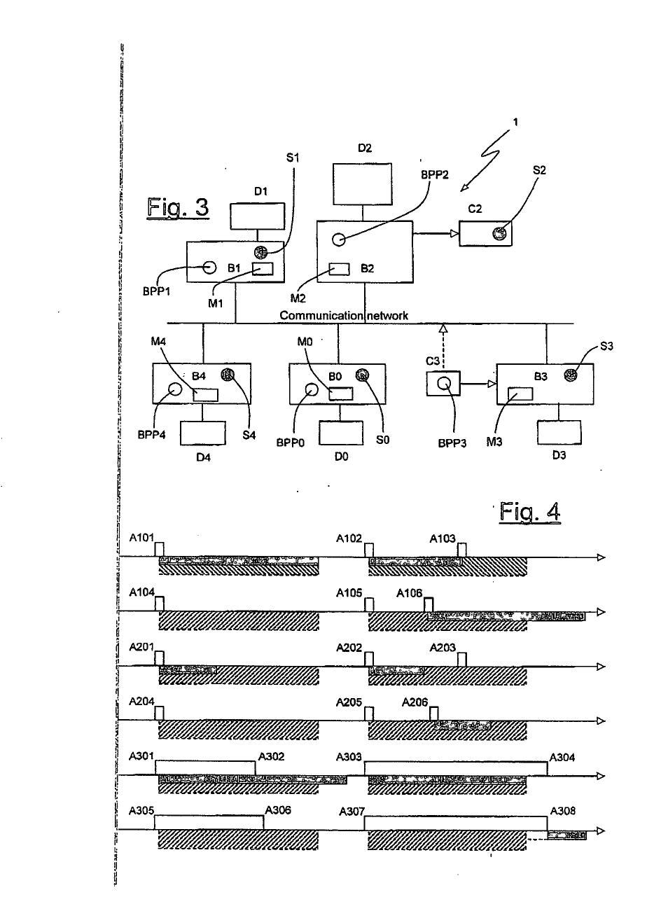

The installation 1 represented in FIG. 3 chiefly comprises networked elements referenced B0, B1, B2, B3 and B4 making it possible to control equipment D0, D1, D2, D3 and D4 of a building. Each element comprises a pushbutton BPP0, BPP1, BPP2, BPP3 and BPP4 making it possible to switch it to learning mode and a means of emitting an information signal S0, S1, S2, S3 and S4. Each element also comprises a memory M0, M1, M2, M3 and M4 exhibiting in particular a program P2 making it possible to detect actions exerted on the pushbuttons, to manage timeouts and emission of information signals.

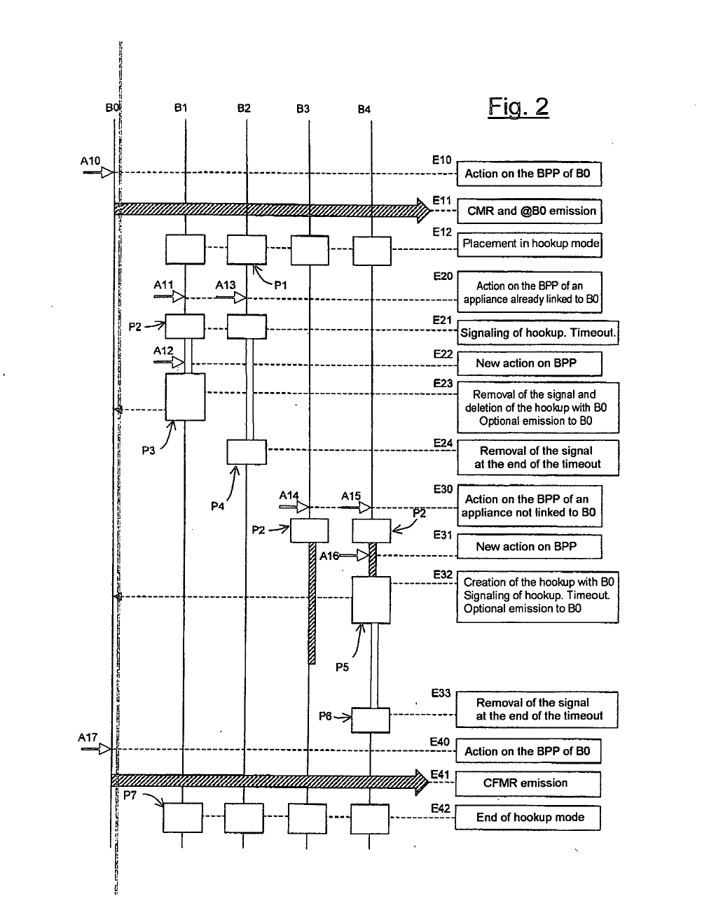

In the group assembly process illustrated in FIG. 2, it is assumed that an initial group comprising the elements B0, B1 and B2 is already assembled and that the aim of the installer is to exclude the element B1 from this group and to include the element B4 in it.

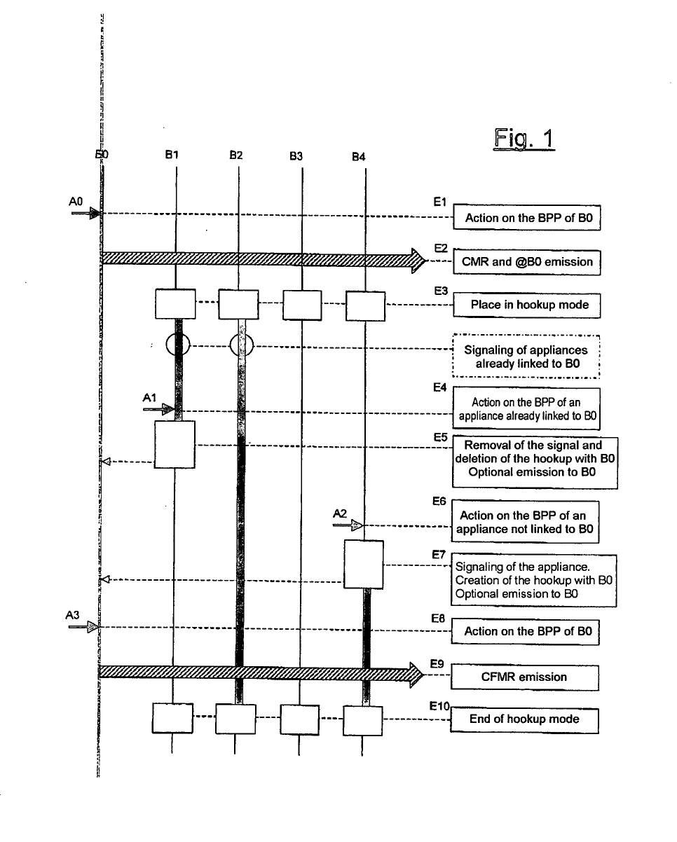

The first three steps referenced E10 to E12 are identical to steps El to E3 described with reference to FIG. 1 and make it possible to initialize a session for assembling a group of elements.

The various elements of the network comprise a subprogram P1 or a functional block able to recognize a command for placing in learning mode CMR and, once in this mode, they record at least provisionally the address @B0 accompanying the command CMR. In contradistinction to the known process of the prior art, the toggling of each of the elements into the learning mode does not engender any emission of a signal of membership or of non-membership in the initial group of elements.

During a step E20, the installer engenders actions All and A13 on the elements B1 and B2 belonging to the initial group. These actions will not in principle be performed simultaneously. The installer normally deals with one of the elements before dealing with the other.

The succession of actions concerning the element B1 is firstly considered. During a step B1/E21, the action All engenders the activation of a subprogram P2. This subprogram tests the existence of a hookup between the element B0 and the element B1. After noting the existence of this hookup and therefore the membership of the element B1 in the group, the element B1 then activates a timeout of duration T and emits a signal informing of its membership in the group. The emission of this signal is represented by a thick black line.

During a new step B1/E22, the installer exerts an action A12 on the pushbutton BPP of the element B1 before the expiry of the timeout T. This action prompts a step B1/E23, in the course of which a subprogram P3 is activated and interprets this action as a command for deleting the existing hookup between the element B1 and the group. Once the hookup has been removed, that is to say once the element B1 has been excluded from the group, the emission of the information signal is deactivated. A message may possibly be addressed to the element B0 to inform it of the removal of the hookup. This message may be used by the whole collection of elements of the group, or even by the whole collection of elements of the network.

The element B1 then no longer changes state until the end of the group assembly session.

The succession of actions concerning the element B2 are now considered. During a step B2/E21, the action A13 engenders the activation of subprogram P2. This subprogram tests, as seen previously, the existence of a hookup between the element B0 and the element B2. After noting the existence of this hookup and therefore the membership of the element B2 in the group, the element B2 then activates a timeout of duration T and emits a signal informing of its membership in the group. The emission of this signal is represented by a thick black line. During a new step B1/E24, the timeout expires without the installer having exercised any action on the pushbutton BPP of the element B2. This engenders the activation of a subprogram P4 which puts an end to the emission of the information signal. No action having been detected for the duration of the timeout, the element B2 is still included in the group.

The element B2 then no longer changes state until the end of the group assembly session.

During a step E30, the installer engenders actions A14 and A15 on elements B3 and B4 that are not members of the group. These actions will in principle not be performed simultaneously. The installer normally deals with one of the elements before dealing with the other.

The succession of actions concerning the element B3 is firstly considered. During a step B3/E30, the action A14 engenders the activation of a subprogram P2. This subprogram tests the existence of a hookup between the element B0 and the element B3. After noting the absence of this hookup and therefore the non-membership of the element B3 in the group, the element B3 then activates a timeout of duration T (represented by the hatched rectangle) and emits a signal or does not emit any signal to signify its non-membership in the group. No action having been detected during the timeout, no change of state of the element B3 is performed. The element B3 remains excluded from the group and no longer changes state up to the end of the group assembly session.

The succession of actions concerning the element B4 is firstly considered. During a step B4/E30, the action A15 engenders the activation of a subprogram P2. This subprogram tests the existence of a hookup between the element B0 and the element B4. After noting the absence of this hookup and hence the non-membership of the element B4 in the group, the element B4 then activates a timeout of duration T and emits a signal or does not emit any signal to signify its non-membership in the group. During a new step B4/E31, the installer exercises an action A16 on the pushbutton BPP of the element B4 before the expiry of the timeout T. This action prompts a step B4/E32, during which a subprogram P5 is activated and interprets this action as a command for creating a hookup between the element B4 and the element B0. This action also triggers a timeout. Once the hookup has been created, that is to say once the element B4 has been included in the group, the emission of an information signal regarding the membership of the element B4 in the group is activated. A message may possibly be addressed to the element B0 to inform it of the creation of the hookup. This message may be used by the whole collection of elements of the group, or even by the whole collection of elements of the network.

The end of the timeout triggered by the action A16 prompts step E33, during which a subprogram makes it possible to note that no action has arisen to call into question the creation of the previous hookup and which puts an end to the emission of the information signal. The element B4 remains included in the group and no longer changes state until the end of the group assembly session.

Of course, the benefit of the process is to make it possible to repeatedly modify the states (included/excluded) of the various elements of the network in the course of one and the same grouping session, by random succession of the four particular cases just seen. In the case described here, the installer decides to put an end to the group assembly session by an action A17, which, as in the prior art, gives rise to emission of an end of learning mode command CFMR.

On termination of the group assembly session, the element B1 has been excluded from the group, the element B4 has been integrated into it, the element B2 remains in the group and the element B3 remains outside the group.

The implementation of the invention lends itself to numerous alternatives, in particular depending on whether a programming command means in the form of a brief-pulse or sustained-pulse pushbutton is used, and depending on the mode of emission of information signals that is adopted.

FIG. 4 illustrates three alternatives for executing the process, with actions that have taken place during a group assembly session. Time flows horizontally from left to right in this figure.

In the case of a programming means such as a brief-pulse pushbutton, each pulse (depress/release) of the button is regarded as a single action. In FIG. 4, these actions are represented by narrow white rectangles referenced A101 to A106 and A201 to A206.

In the case of a programming means such as a pushbutton allowing sustained pulses, the depressing of the button is regarded as a first action (for example A301) while its release is regarded as a second action (for example A302). The duration of depression of the key is depicted by a white rectangle.

A first alternative is represented on the first two lines of FIG. 4. The programming means is a pushbutton with brief pulses. The first line corresponds to the case of an element that is already a member of the group at the time at which the action on the pushbutton BPP takes place. An action A101 engenders the triggering of a timeout T represented by a hatched rectangle and the activation of the information signal is represented by a dark grey rectangle. The emission of the information signal ceases if no new action is detected during the timeout T. The element then still forms part of the group.

An action A102 “interrogates” the element again about its state. Again, the timeout T and the emission of the information signal are activated. However, this time, a new action A103 takes place before the expiry of the timeout. This action is then interpreted as a command for exclusion from the group, and the information signal regarding the membership of the element in the group is deactivated. It is possible and preferable at this juncture to also deactivate the timeout T. It is however represented here as running to term so as to clearly show that the action A103 takes place before its expiry.

The second line therefore corresponds to the case where the element is not a member of the group at the time at which the action on the button BPP takes place. An action A104 engenders the triggering of a timeout T but does not engender the emission of any signal. No action having taken place during the timeout, the element remains excluded from the group. An action A105 again engenders the triggering of the timeout T. This time, an action A106 takes place before the expiration of the timeout. This action is then interpreted as command for attaching the element to the group. A hookup is created between the element and the group and a signal attesting to this creation or to this membership in the group is activated. Preferably, the timeout T is then deactivated and a new timeout T′ is activated. The element thus finds itself after the action A106 in a state comparable to that appearing after the action A101.

The third and fourth lines pertain to the case of a second alternative characterized by the emission of a short information signal, in particular so as to yet further preserve the energy consumed or to preclude lengthy movements when the signal consists of the displacement of an item of equipment by an actuator. This time, there is a distinction between the timeout T′ for establishing the signal and the timeout T during which an appliance “remains listening” for a change of state order.

An action A201 is applied to an element that is already a member of the group. There is therefore signaling, for a duration T′ and “listening” for a duration T here greater than T′. Since no action is applied for the duration of listening, the element remains in its state of membership in the group.

Upon an action A202, the element again emits an information signal for a duration T′. This time, an action A203 takes place in the listening duration T. This action is interpreted as an exclusion command and the communication hookup making it possible to attach the element to the group is deleted.

Pursuant to the actions A204 and A205, the element, not being a member of the group, emits no information signal. A following action A206 takes place during the listening timeout T and is therefore interpreted as an order for attaching the element to the group. This action A206 engenders the learning of a communication hookup and a new timeout T′ during which an information signal is emitted.

In a preferred manner, the previous timeout T is then deactivated, and a new timeout T is activated, in such a way that the situation after the action A206 becomes identical to that after the action A201.

A third alternative is illustrated on the last two lines. This pertains to the case of the use of a programming means such as a pushbutton allowing sustained pulses, returning to the case of the emission of a “lengthy” information signal which remains, of course, very short as compared with the prior art.

An action A301 is applied to an element which is already a member of the group. This action engenders the triggering of a timeout T and the activation of the signal attesting the membership of the element in the group. If the pushbutton is released during the timeout (action A302), this action is interpreted as a confirmation of membership. The emission of the signal may possibly be prolonged by the activation of a timeout T″ pursuant to this action.

On the other hand, in the same initial state of membership, if an action A303 is prolonged beyond the time T, the signal ceases, and an action A304 is interpreted as an exclusion command.

An action A305 is now applied to an element not forming part of the group. It engenders a timeout T but not signal activation. The release of the key (action A306) occurring before the end of the timeout is interpreted as a confirmation of the state of exclusion of the element. Starting from this exclusion situation, an action A307 again engenders a “listening” timeout of duration T. Beyond this duration, a release action A308 is interpreted as an attachment command.

Release during the timeout could also be regarded as an order for modification of the state of the element and release beyond the timeout as an order for maintaining the state of the element.

As a preferred variant, provision may also be made for the change of state to be engendered here by the exceeding of the timeout T, stated otherwise, for the signal of membership in the group to be activated as soon as this timeout ends.

It is also preferred to trigger a new timeout T as soon as T′ ends. If the key remains depressed in a prolonged manner, one switches alternately from a situation of attachment to a situation of exclusion and vice versa. However, ultimately, it is the time at which the key is released which determines the final state of membership in the group, depending on whether the key is released during the emission of a membership or exclusion signal. According to this alternative, the signal alone is modified after each timeout as long as the key remains depressed, and any change of state is recorded only at the time of the release of the key.

Finally, the operational ergonomics may be enhanced through the emission of an information signal making it possible to indicate the membership of the element in the group and another information signal making it possible to indicate the non-membership of the element in the group. For example, a light-emitting diode displays a green light to attest to membership in the group and displays an orange light upon a timeout, to indicate exclusion from the group.

Although, for simplicity, only the assembling of the group by the learning by each element of the group of the address of a master element has been described, the invention is independent of the group assembly method used.

In this patent application, the term “action” should be interpreted in a broad sense. In particular, the absence of action for the duration of the timeout may constitute an “action” that ought to be interpreted by the element as an order for modifying its state of membership in the group.

1. A process for assembling a group of networked elements controlling equipment of a building, wherein when the elements are in a learning mode,
a first action exerted on one of the elements is interpreted as an interrogation concerning its state of membership in the group (included—excluded) and triggers the emission of an information signal regarding its state, and
a following action exerted on this element is interpretable as an order for modifying its state of membership in the group.

2. The process for assembling a group of elements as claimed in claim 1, wherein the element emits this information signal during a timeout (T′).

3. The process for assembling a group of elements as claimed in claim 1, wherein the first action triggers a timeout (T) during which the following action or actions exerted on the element is or are interpreted by the element as an order for modifying its state of membership in the group.

4. The process for assembling a group of elements as claimed in claim 1, wherein the following action or actions, interpreted by the element as an order for modifying its state of membership in the group, triggers or trigger a timeout (T″) during which the element emits an information signal regarding its state of membership in the group.

5. The process for assembling a group of elements as claimed in claim 1, wherein the following action or actions, interpreted by the element as an order for modifying its state of membership in the group, triggers or trigger a timeout during which the action or actions exerted on the element is or are interpreted by the element as an order for modifying its state of membership in the group.

6. The process for assembling a group of elements as claimed in claim 1, wherein the following action or actions exerted on the element, that is not or are not interpreted by the element as an order for modifying its state of membership in the group, is or are interpreted as a first action exerted on the element.

7. The process according to claim 1, wherein the action exerted on an element consists of a pulse engendered manually on a programming means (BPP0, BPP1, BPP2, BPP3, BPP4) relating to this element.

8. An installation comprising equipment of a building, which equipment is controlled by networked elements, which installation is intended to implement the process as claimed in claim 1, each element comprising a programming means, a means of emitting an information signal, a memory containing a program for detecting a command for placing in learning mode and a program for detecting end of placement in learning mode, wherein the memory of each element comprises a program for detection of action on the means of programming, of management of timeouts and of emission of an information signal.

9. The installation as claimed in claim 8, wherein at least one of the elements exhibits a programming means and/or a means of emission of information signal physically separate from the element.
